(19) United States
(12) Patent Application Publication
(10) Pub. No.: US 2017/0093255 A1
(43) Pub. Date: Mar. 30, 2017

(54) ELECTRONIC CONTROLLER FOR ELECTRIC POWER STEERING

(71) Applicant: NIDEC ELESYS CORPORATION, Kawasaki-shi (JP)

(72) Inventors: Kazuki HARADA, Kawasaki-shi (JP); Daiji HOTTA, Kawasaki-shi (JP)

(21) Appl. No.: 15/274,006

(22) Filed: Sep. 23, 2016

Related U.S. Application Data
(60) Provisional application No. 62/232,590, filed on Sep. 25, 2015.

(51) Int. Cl. H02K 11/33; B62D 5/04; H02K 9/22; H02K 11/00; H02K 11/20

(52) U.S. Cl. CPC H02K 11/33; H02K 11/0094; H02K 11/20; H02K 9/22; B62D 5/0409

(57) ABSTRACT

An electronic controller used in electric power steering includes a first substrate including a switching circuit to supply a drive signal to an electric motor and at least one electrolytic capacitor to smooth a power-supply voltage that is a source of the drive signal. The at least one electrolytic capacitor is mounted on a first surface (a bottom surface of a frame), the switching circuit and the at least one electrolytic capacitor are mounted on a surface of the first substrate that is different from the first surface, and the at least one electrolytic capacitor and the first substrate are arranged above and below the switching circuit, respectively.

### CROSS REFERENCE TO RELATED APPLICATIONS

This application is related to Japanese Patent Application No. 2013-066899 filed Mar. 27, 2013 and claims the benefit of U.S. Provisional Application No. 62/232,590 filed on Sep. 25, 2015. The entire contents of each application are hereby incorporated herein by reference.

### BACKGROUND OF THE INVENTION

1. Field of the Invention

The present invention relates to an electronic controller, and more specifically to an electronic controller used in electric power steering, and the like.

2. Description of the Related Art

A vehicle such as an automobile can include an electric power steering apparatus, and the electric power steering apparatus generates assist torque to assist the steering torque in a steering system that is generated by the operation of a steering handle by a driver. By the generation of the assist torque, the electric power steering apparatus can reduce the burden on the driver. An assist torque mechanism to give the assist torque detects a steering torque in the steering system with a steering torque sensor, generates a drive signal with an electronic controller based on the detection signal, generates an assist torque corresponding to the steering torque with an electric motor based on the drive signal, and transmits the assist torque to the steering system by a speed reduction mechanism.

For example, Japanese Patent Laid-Open No. 2010-63242 discloses a structure of the electronic controller for electric power steering. A motor control device 200 (electronic controller) in FIG. 3 of Japanese Patent Laid-Open No. 2010-63242 is formed on a lateral portion of a motor 100, integrally with the motor 100.

Here, in FIG. 14 of Japanese Patent Laid-Open No. 2010-63242, a terminal C3NT on the negative side of the electrolytic capacitor C3 is connected with a bus bar 230BNN by welding (Paragraph [0045] of Japanese Patent Laid-Open No. 2010-63242), and in FIG. 4 of Japanese Patent Laid-Open No. 2010-63242, the bus bar 230BNN is connected with a power lead frame 230BN by welding (Paragraph [0028] of Japanese Patent Laid-Open No. 2010-63242). Therefore, the production process of the motor control device 200 (electronic controller) becomes complex or troublesome. Further, in FIG. 1, FIG. 5 and FIG. 11 of Japanese Patent Laid-Open No. 2010-63242, a DC module 230 or electrolytic capacitors C2, C3 are arranged on the left or right relative to a power module 210, in other words, the DC module 230 and the power module 210 are arranged in a planar manner, resulting in a bulge or a size increase of a motor control device 200.

Generally, it is desirable that the electronic controller for electric power steering have a small size. However, it is difficult for a person skilled in the art to produce a small-size electronic controller for electric power steering.

### SUMMARY OF THE INVENTION

Preferred embodiments of the present invention provide a small-size electronic controller used in electric power steering. Other benefits of preferred embodiments of the present invention will be readily apparent, by reference to the below-exemplified aspects, preferred embodiments, and accompanying drawings.

In the following, aspects according to various preferred embodiments of the present invention will be exemplified for facilitating the understanding of the summary of the present invention.

A first aspect according to a preferred embodiment of the present invention relates to an electronic controller used in electric power steering, the electronic controller being provided integrally with an electric motor, the electronic controller including a first substrate that includes a switching circuit and at least one electrolytic capacitor, the switching circuit supplying a drive signal to the electric motor, the at least one electrolytic capacitor smoothing a power-supply voltage that is a source of the drive signal, the at least one electrolytic capacitor being mounted on a first surface, the switching circuit and the at least one electrolytic capacitor being mounted on a surface of the first substrate, the surface of the first substrate being different from the first surface, the at least one electrolytic capacitor and the first substrate being arranged above and below the switching circuit, respectively.

When the switching circuit and the at least one electrolytic capacitor are mounted on the surface of the first substrate, the at least one electrolytic capacitor is mounted on the first surface that is different from the surface of the first substrate. In other words, it is possible to arrange the at least one electrolytic capacitor on the first surface in a separate manner. Particularly, the at least one electrolytic capacitor and the first substrate are arranged above and below the switching circuit, respectively, and thus, it is possible to inhibit a bulge of the electronic controller and to provide a small-size electronic controller for use in electric power steering.

As a second aspect according to a preferred embodiment of the present invention, the switching circuit may include a plurality of switching transistors, the at least one electrolytic capacitor may include a plurality of electrolytic capacitors that are mounted on the first surface, and at least a portion of the plurality of electrolytic capacitors may be arranged above at least a portion of the plurality of switching transistors.

Since at least a portion of the plurality of electrolytic capacitors may be arranged above at least a portion of the plurality of switching transistors, it is possible to efficiently arrange the plurality of switching transistors and the plurality of electrolytic capacitors on the first substrate (power substrate). In other words, in the second aspect, it is possible to utilize a dead space above a semiconductor switching element.

As a third aspect according to a preferred embodiment of the present invention, the first substrate may further include a noise filter that absorbs noise contained in the power-supply voltage, the noise filter may be mounted on the first surface, and the noise filter may be arranged above the switching circuit.

In the third aspect, it is possible to arrange not only the at least one electrolytic capacitor but also the noise filter on the first surface in a steric manner.

As a fourth aspect according to a preferred embodiment of the present invention, a positive electrode terminal and a negative electrode terminal are connected with a positive electrode and a negative electrode of the at least one electrolytic capacitor on the first surface, respectively, the positive electrode terminal having an electric potential of a positive electrode of a direct-current power supply, the negative electrode terminal having an electric potential of a negative electrode of the direct-current power supply, the direct-current power supply specifying the power-supply voltage, and the at least one electrolytic capacitor may be mounted on the surface of the first substrate, by a connection surface of the positive electrode terminal and a connection surface of the negative electrode terminal.

The at least one electrolytic capacitor is mounted on the surface of the first substrate, by the connection surface of the positive electrode terminal and the connection surface of the negative electrode terminal, in a state in which the positive electrode and negative electrode of the at least one electrolytic capacitor are connected with the positive electrode terminal and the negative electrode terminal on the first surface. In other words, the first surface is different from the surface of the first substrate, and therefore, the at least one electrolytic capacitor is easily mounted on the surface of the first substrate.

As a fifth aspect according to a preferred embodiment of the present invention, the switching circuit and the at least one electrolytic capacitor may be collectively mounted on the surface of the first substrate by reflow soldering.

Since the switching circuit and the at least one electrolytic capacitor are collectively mounted on the surface of the first substrate, it is possible to simplify the production process of the electronic controller used in electric power steering.

A person skilled in the art will easily understand that the exemplified aspects according to preferred embodiments of the present invention can be further modified without departing from the spirit of the present invention.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 shows a schematic configuration example of an electric power steering apparatus according to a preferred embodiment of the present invention.

FIG. 2 shows an external appearance example of an electronic controller used in electric power steering according to a preferred embodiment of the present invention.

FIG. 3 shows an exemplary exploded perspective view of an electronic controller according to a preferred embodiment of the present invention in FIG. 2 including a cover.

FIG. 4 shows an exemplary circuit block diagram expressing a first substrate in FIG. 3 according to a preferred embodiment of the present invention.

FIG. 5A shows an exemplary exploded perspective view of the first substrate in FIG. 3 according to a preferred embodiment of the present invention, and FIG. 5B shows an exemplary perspective view of a main structure of a first component in FIG. 5A.

FIG. 6 shows an exemplary functional block diagram of a second substrate in FIG. 3 according to a preferred embodiment of the present invention.

FIG. 7A shows an exemplary perspective view of a combinational structure of the first substrate and a relay member in FIG. 3 according to a preferred embodiment of the present invention, and FIG. 7B shows an exemplary perspective view of the combinational structure of the first substrate, the relay member and the second substrate in FIG. 3 according to a preferred embodiment of the present invention.

### DETAILED DESCRIPTION OF THE PREFERRED EMBODIMENTS

Preferred embodiments of the present invention described below are described to facilitate the understanding of the present invention. Accordingly, it is noted that the present invention is not limited to only the preferred embodiments described in detail below.

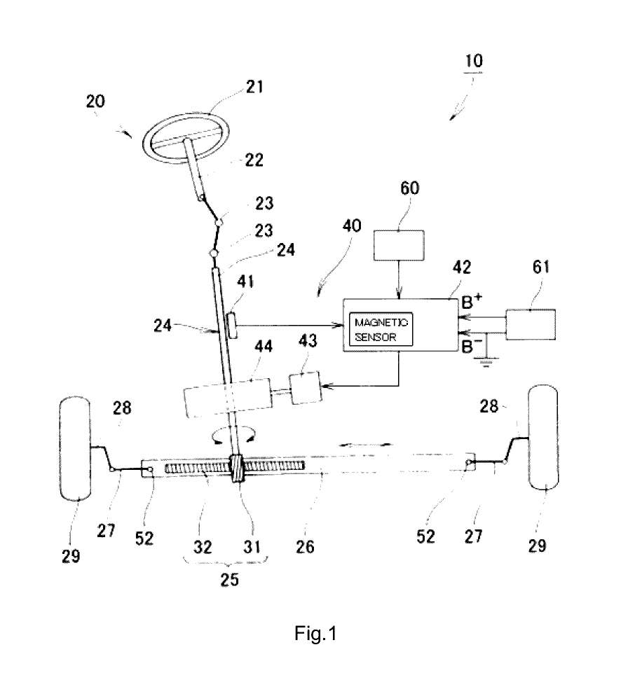

FIG. 1 shows a schematic configuration example of an electric power steering apparatus 10 according to a preferred embodiment of the present invention. In the example of FIG. 1, the electric power steering apparatus 10 includes an electronic controller (also referred to as a control unit) 42 for electric power steering. Specifically, the electric power steering apparatus 10 includes an assist torque mechanism 40 that provides assist torque (also referred to as additional torque) to a steering system 20 extending from a steering handle (for example, a steering wheel) 21 for a vehicle to steered wheels (for example, front wheels) 29 for the vehicle.

In the example of FIG. 1, the steering system 20 links a rotation axis 24 (also referred to as a pinion axis or an input axis) with a steering handle 21 by a steering shaft 22 (referred to as a steering column) and universal couplings 23, 23, links a rack axis 26 with the rotation axis 24 by a rack-and-pinion mechanism 25, and links the right and left steered wheels 29 with both ends of the rack axis 26 by right and left ball joints 52, tie rods 27 and knuckles 28. The rack-and-pinion mechanism 25 includes a pinion 31 in the rotation axis 24 and a rack 32 in the rack axis 26.

According to the steering system 20, a driver steers the steering handle 21, and by that steering torque, is able to steer the steered wheels 29 by the rack-and-pinion mechanism 25.

In FIG. 1, the assist torque mechanism 40 is a mechanism that detects the steering torque of the steering system 20 given to the steering handle 21 with a steering torque sensor 41, generates a drive signal with the electronic controller 42 based on the detection signal (also referred to as the torque signal), generates an assist torque (additional torque) corresponding to the steering torque with an electric motor 43 based on the drive signal, transmits the assist torque to the rotation axis 24 by a speed reduction mechanism 44 (for example, a worm gear mechanism), and further, transmits the assist torque from the rotation axis 24 to the rack-and-pinion mechanism 25 of the steering system 20.

The electric power steering apparatus 10 can be classified into a pinion assist type, a rack assist type, a column assist type and the like, according to the place where the assist torque is given to the steering system 20. The electric power steering apparatus 10 in FIG. 1 is the pinion assist type, but the rack assist type, the column assist type and the like may be applied as the electric power steering apparatus 10.

The electric motor 43, for example, is preferably a brushless motor, and the rotation angle of the rotor of the brushless motor or the rotation angle of the electric motor 43 (also referred to as the rotation signal) is detected by the electronic controller 42. The rotor, for example, is preferably defined by a permanent magnet, and the electronic controller 42 is able to detect the motion of the permanent magnet (the N-pole and the S-pole), with a magnetic sensor.

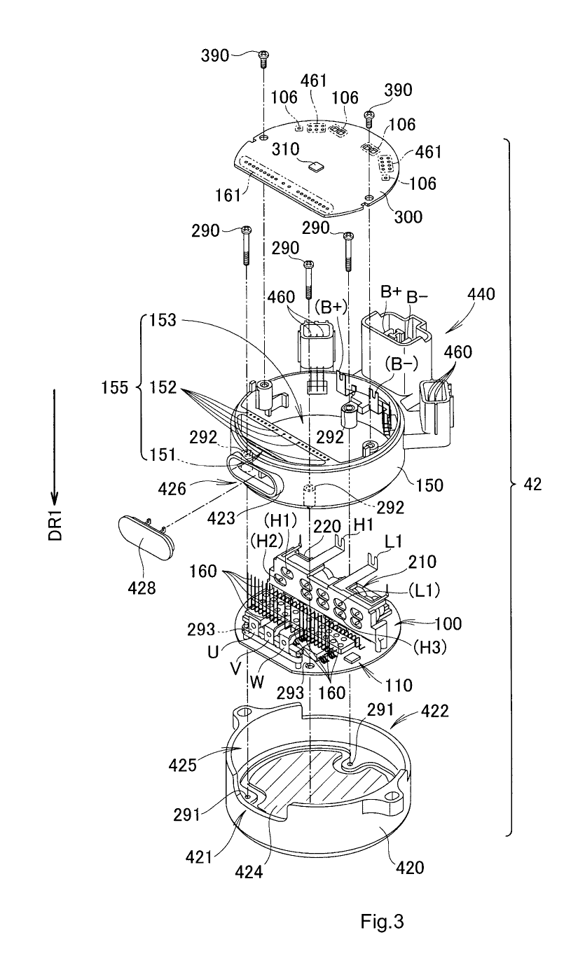

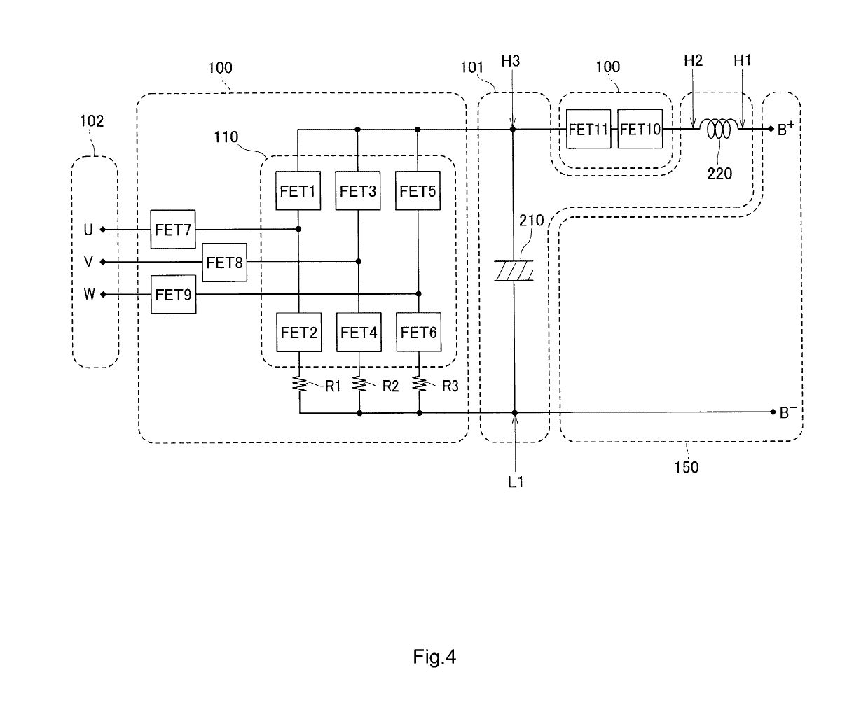

The electronic controller 42, for example, is preferably defined by a power-supply circuit, a current sensor that detects a motor current (actual current), a microprocessor, an Field Effect Transistor (FET) bridge circuit, the magnetic sensor and the like. In addition to the torque signal, a vehicle speed signal, for example, can be input to the electronic controller 42, as an external signal. An external device 60 is another electronic controller that can communicate through an in-vehicle network such as, for example, a CAN (Controller Area Network), and may be, for example, a vehicle speed sensor that outputs a vehicle speed pulse corresponding to the vehicle speed signal. Here, the external signal includes system-side signals such as the torque signal and vehicle-body-side signals (vehicle-body signals) such as the vehicle speed signal, and the vehicle-body signal can include not only communication signals such as the vehicle-speed signal and engine speed but also an ON/OFF signal for an ignition switch. The microprocessor of the electronic controller 42 performs the vector control of the electric motor 43, for example, based on the torque signal, the vehicle speed signal and the like. The FET bridge circuit controlled by the microprocessor is preferably defined, for example, by a switching circuit 110 including an FET 1, an FET 2, an FET 3, an FET 4, an FET 5 and an FET 6 (see FIG. 4) to carry a drive current (three-phase alternating current) to the electric motor 43 (brushless motor). The magnetic sensor, for example, is preferably defined by a Hall IC 310 (see FIG. 3).

Such an electronic controller 42 sets a target current based on at least the steering torque (torque signal), and preferably, sets the target current, also in consideration of the vehicle speed (vehicle speed signal, vehicle speed pulse) detected by the vehicle speed sensor and the rotation angle (rotation signal) of the rotor detected by the magnetic sensor. The electronic controller 42 controls the drive current (drive signal) of the electric motor 43 such that the motor current (actual current) detected by the current sensor coincides with the target current.

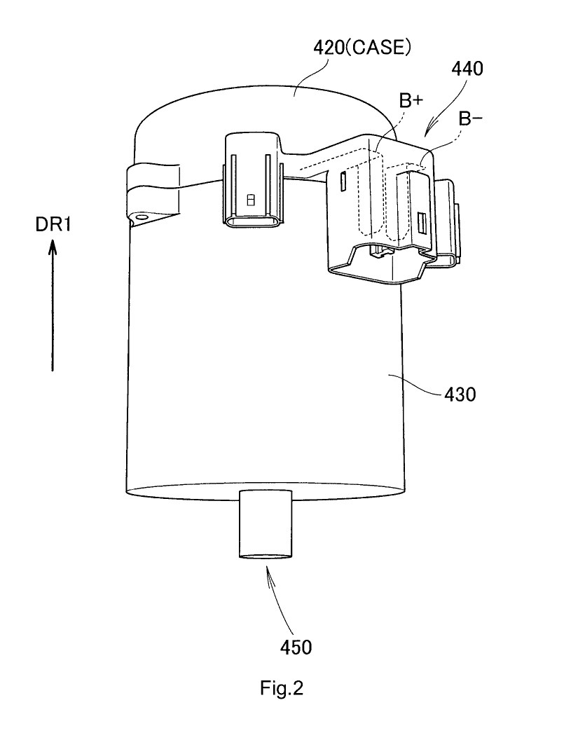

Reference character B+ denotes the electric potential of a positive electrode of a battery 61 that is provided in the vehicle as a direct-current power source, for example. Reference character B− denotes the electric potential of a negative electrode of the battery 61, and the electric potential B− of the negative electrode can be grounded on the vehicle body of the vehicle. Here, the electronic controller 42, for example, includes input terminals B+, B− (first input terminals, battery terminals) in an external connector 440 (see FIG. 2), and the external connector 440 is able to supply the electric power from the battery 61, to the electronic controller 42. The power-supply voltage (the difference between the electric potential B+ of the positive electrode and the electric potential B− of the negative electrode) is a source of the drive signal of the electric motor 43.

According to the electric power steering apparatus 10, it is possible to steer the steered wheels 29 via the rack axis 26, by a combined torque resulting from adding the assist torque (additional torque) of the electric motor 43 to the steering torque by the driver.

FIG. 2 shows an external appearance example of the electronic controller for use in electric power steering according to a preferred embodiment of the present invention. In the example of FIG. 2, a cover 420 is a cover of the electronic controller 42 in FIG. 1, and a motor cover 430 is a cover of the electric motor 43 in FIG. 1. The electronic controller 42 is provided integrally together with the electric motor 43, such that the cover 420 is arranged in the direction of a motor axis 450 of the electric motor 43. When a direction DR1 is pointed at the upper side of the electric motor 43 in the example of FIG. 2, the electronic controller 42 can be provided at an upper portion of the electric motor 43, integrally with the electric motor 43. Here, the external connector 440, which is positioned at a lateral portion of the motor axis 450, includes the input terminal B+ that inputs the electric potential of the positive electrode of the external battery 61 and the input terminal B− that inputs the electric potential of the negative electrode of the external battery 61, and includes at least one terminal 460 (second input terminal, signal terminal) that connects the steering torque sensor 41 and the like with the electronic controller 42 (see FIG. 3).

FIG. 3 shows an exemplary exploded perspective view of the electronic controller 42 including the cover 420 in FIG. 2. In the example of FIG. 3, the electronic controller 42 preferably includes a first substrate 100, a second substrate 300, a relay member 150, and the cover 420. However, the electronic controller 42 is not limited to the example of FIG. 3, in other words, it is possible to provide the small-size electronic controller 42 when the electronic controller 42 includes at least the small-size first substrate 100 shown in FIG. 3. Here, the first substrate 100 includes a switching circuit 110 to supply the drive signal to the electric motor 43 and at least one electrolytic capacitor 210 to smooth the power-supply voltage that is a source of the drive signal.

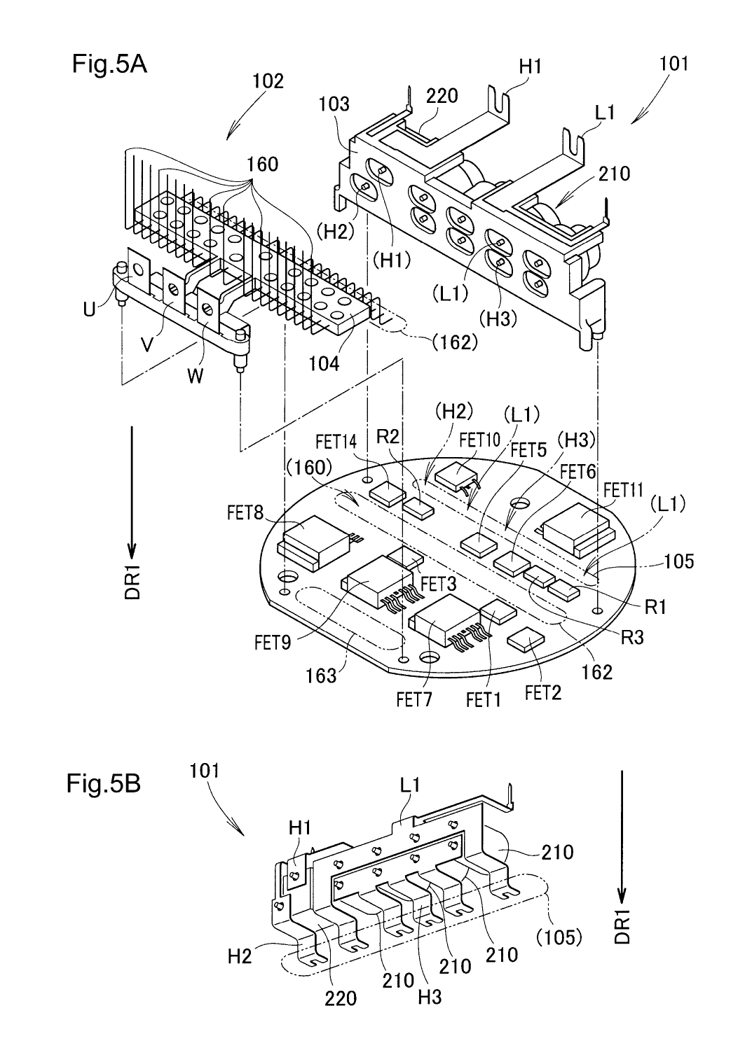

FIG. 4 shows an exemplary circuit block diagram expressing the first substrate 100 in FIG. 3 according to a preferred embodiment of the present invention. In the example of FIG. 4, reference character B+ denotes the input terminal inputting the electric potential of the positive electrode of the battery 61 in FIG. 1, and reference character B− denotes the input terminal inputting the electric potential of the negative electrode of the battery 61. The first substrate 100 generates the drive signal of the electric motor 43 in FIG. 2, with the switching circuit 110, and includes three output terminals U, V, W outputting the drive signal. Here, the drive signal, for example, is preferably generated based on the power-supply voltage (the difference between the electric potential B+ of the positive electrode and the electric potential B− of the negative electrode) input from the two input terminals B+, B− (first input terminals, battery terminals) of the relay member 150 in FIG. 3. Here, the electric potential B+ of the input terminal of the external connector 440 of the relay member 150 in FIG. 3 is the same as the electric potential of connection terminals H1, H2, H3 of a first component 101 of the first substrate 100 in FIG. 3 or the first substrate 100 in FIG. 5B, and the electric potential B− of the input terminal of the external connector 440 of the relay member 150 in FIG. 3 is the same as the electric potential of a connection terminal L1 of the first component 101 of the first substrate 100 in FIG. 3 or the first substrate 100 in FIG. 5B.

In the example preferred embodiment of FIG. 4, the switching circuit 110 is preferably a three-phase FET bridge circuit FET 1 to FET 6 that is defined by six FETs of FET 1 to FET 6, and is connected with the at least one electrolytic capacitor 210 in parallel, with respect to a line of the electric potential B+ of the input terminal of the positive electrode and a line of the electric potential B− of the input terminal of the negative electrode. The switching circuit 110 may include a plurality of switching transistors (for example, IGBTs) other than FETs. Here, the at least one electrolytic capacitor 210, for example, is defined by four electrolytic capacitors (see FIG. 5B).

The FET 1 and the FET 2, which are connected in series between the line of the electric potential B+ of the positive electrode and the line of the electric potential B− of the negative electrode, can generate the U-phase current that flows through, for example, the U-winding of the electric motor 43. As a current sensor that detects the U-phase current, a shunt resistor R1, for example, can preferably be provided between the FET 2 and the line of the electric potential B− of the negative electrode, and as a semiconductor relay that interrupts the U-phase current, an FET 7, for example, can be provided between a connection node of the FET 1 and FET 2 and an output terminal U of the electric motor 43.

The FET 3 and the FET 4, which are connected in series between the line of the electric potential B+ of the positive electrode and the line of the electric potential B− of the negative electrode, generate the V-phase current that flows through, for example, the V-winding of the electric motor 43. As a current sensor that detects the V-phase current, a shunt resistor R2, for example, can preferably be provided between the FET 4 and the line of the electric potential B− of the negative electrode, and as a semiconductor relay capable of interrupting the V-phase current, an FET 8, for example, can be provided between a connection node of the FET 3 and FET 4 and an output terminal V of the electric motor 43.

The FET 5 and the FET 6, which are connected in series between the line of the electric potential B+ of the positive electrode and the line of the electric potential B− of the negative electrode, generate the W-phase current that flows through, for example, the W-winding of the electric motor 43. As a current sensor to detect the W-phase current, a shunt resistor R3, for example, can be provided between the FET 6 and the line of the electric potential B− of the negative electrode, and as a semiconductor relay that interrupts the W-phase current, an FET 9, for example, can be provided between a connection node of the FET 5 and FET 6 and an output terminal W of the electric motor 43.

In the example preferred embodiment of FIG. 4, the switching circuit 110 supplies, as the drive signal, the U-phase current, the V-phase current and the W-phase current, to the electric motor 43, and the at least one electrolytic capacitor 210 can smooth the power-supply voltage (the difference between the electric potential B+ of the positive electrode and the electric potential B− of the negative electrode) that is a source of the drive signal. The FET 1, the FET 3 and the FET 5 are connected with the line of the electric potential B+ of the positive electrode, by an FET 10 and an FET 11 as an example of a semiconductor relay capable of interrupting the electric power from the battery 61, and by a coil 220 as an example of a noise filter. Here, the coil 220 can absorb the noise contained in the electric potential B+ of the positive electrode. Each of the FET 1 to the FET 11 includes a non-illustrated gate that is connected with one corresponding signal wire of a plurality of signal wires 160 in FIG. 3, and is turned ON or OFF.

Here, for example, three corresponding signal wires of the plurality of signal wires 160 shown in FIG. 3, which are omitted in FIG. 4, are preferably connected with the connection node of the FET 2 and the shunt resistor R1, the connection node of the FET 4 and the shunt resistor R2 and the connection node of the FET 6 and the shunt resistor R3 in FIG. 4, and the U-phase current, the V-phase current and the W-phase current are able to be evaluated from the electric potentials of the connection nodes.

The FET 1 to the FET 11 and the shunt resistor R1 to the shunt resistor R3 in FIG. 4 are provided on the first substrate 100 in FIG. 3 (see FIG. 5A), the at least one electrolytic capacitor 210 and the coil 220 in FIG. 4 are provided on the first substrate 100 in FIG. 3, as the first component 101 (see FIG. 5A), and the output terminals U, V, W in FIG. 4 and the plurality of signal wires 160 omitted in FIG. 4 are provided on the first substrate 100 in FIG. 3, as a second component 102 (see FIG. 5A).

FIG. 5A shows an exemplary exploded perspective view of the first substrate 100 in FIG. 3, and FIG. 5B shows an exemplary perspective view of the main structure of the first component 101 in FIG. 5A. In the example of FIG. 5A, the first substrate 100 preferably includes the FET 1 to the FET 11, the shunt resistor R1 to the shunt resistor R3, the first component 101, and the second component 102. However, the first substrate 100 is not limited to the example of FIG. 5A, in other words, it is possible to provide the small-size first substrate 100 when the at least one electrolytic capacitor 210 and the switching circuit 110 including the FET 1, the FET 2, the FET 3, the FET 4, the FET 5 and the FET 6 are arranged on the first substrate 100, in a steric manner.

In the example of FIG. 5B, the main structure of the first component 101 is preferably defined by four electrolytic capacitors 210, one coil 220 and the connection terminals H1, H2, H3, L1. A frame 103 in FIG. 5A is preferably formed by the molding of the connection terminals H1, H2, H3, L1 with resin, for example, and the four electrolytic capacitors 210 and the one coil 220 are provided on a bottom surface (first surface) of the frame 103. Here, the four electrolytic capacitors 210 and the one coil 220 can be fixed on the bottom surface (first surface) of the frame 103, for example, preferably by a jointing member such as solder. Similarly, the main structure of the second component 102 can preferably be defined by the plurality of signal wires 160 and the three output terminals U, V, W, and a frame 104 in FIG. 5A is formed by the molding of the plurality of signal wires 160 and the three output terminals U, V, W with resin, for example.

Here, the FET 1 to the FET 11, the shunt resistor R1 to the shunt resistor R3, the first component 101 and the second component 102 can be collectively mounted on a surface (front surface) of the first substrate 100 in FIG. 3, by reflow soldering, for example. In other words, the FET 1 to the FET 11, the shunt resistor R1 to the shunt resistor R3, the first component 101 and the second component 102 can be surface-mounted on the first substrate 100. Specifically, in the example of FIG. 5A, a jointing member such as, for example, a solder cream (not illustrated) is previously printed between the surface (front surface) of the first substrate 100 and components such as the FET 1 to the FET 11 and the shunt resistor R1 to the shunt resistor R3, and the components such as the FET 1 to the FET 11 and the shunt resistor R1 to the shunt resistor R3 are attached on the solder cream. Similarly, a jointing member such as, for example, a solder cream (not illustrated) is previously printed also on connection regions 105, 162, 163 of the surface (front surface) of the first substrate 100, and the first component 101 and the second component 102 can be attached on the solder cream. Next, the solder creams are heated, so that the FET 1 to the FET 11, the shunt resistor R1 to the shunt resistor R3, the first component 101 and the second component 102 are connected with the surface (front surface) of the first substrate 100.

In the first substrate 100 in FIG. 3 having this unique structure, when the six FETs of the FET 1 to the FET 6 and the four electrolytic capacitors 210, for example, are mounted on the surface (front surface) of the first substrate 100, the four electrolytic capacitors 210 are mounted on the first surface (the bottom surface of the frame 103) that is different from (specifically, perpendicular or substantially perpendicular to) the surface (front surface) of the first substrate 100. In other words, the four electrolytic capacitors 210 can be arranged on the surface (front surface) of the first substrate 100, in a steric manner. Particularly, at least a portion (for example, two electrolytic capacitors 210) of the four electrolytic capacitors 210 and the first substrate 100 are arranged above and below at least a portion (for example, the FET 5 and the FET 6) of the six FETs of the FET 1 to the FET 6 (see FIG. 5A), respectively, and it is possible to efficiently arrange the six FETs of the FET 1 to the FET 6 and the four electrolytic capacitors 210 on the first substrate 100 (power substrate). Thus, it is possible to inhibit a bulge of the electronic controller 42 and to provide the small-size electronic controller 42. Further, since the coil 210 is arranged, for example, on the FET 4, it is possible to arrange not only the at least one electrolytic capacitor 210 but also the coil 210 (noise filter) on the surface (front surface) of the first substrate 100, in a separate and isolated manner. Furthermore, since the six FETs of the FET 1 to the FET 6 and the four electrolytic capacitors 210, for example, can be collectively mounted on the surface (front surface) of the first substrate 100, it is possible to simplify the production process of the electronic controller 42.

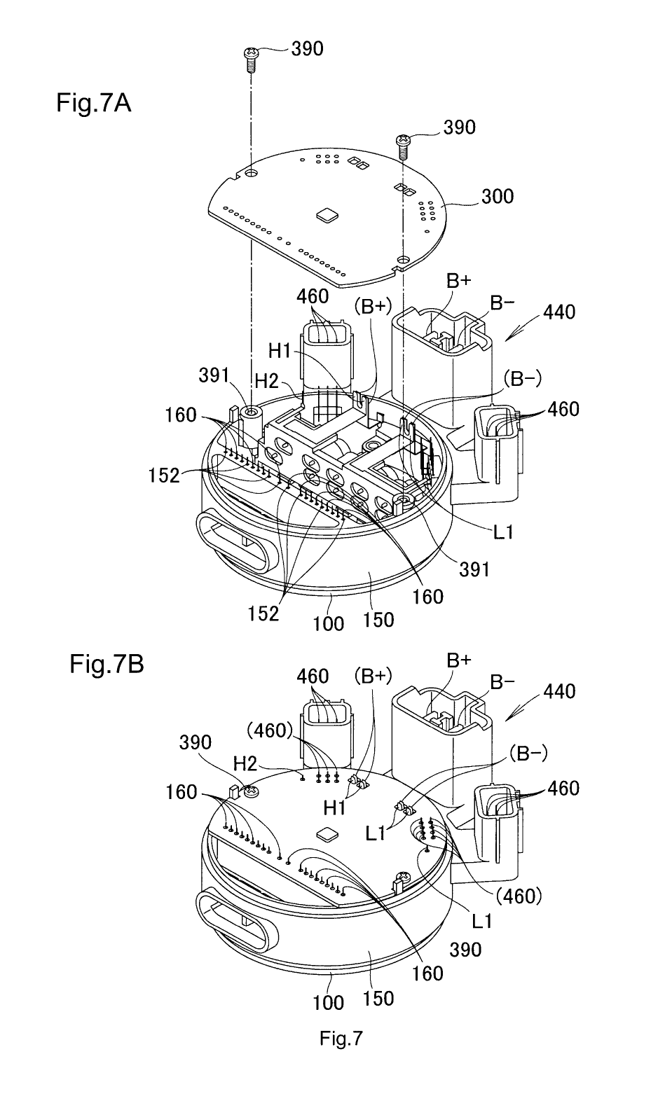

The prior art is unable to provide the benefits of the preferred embodiments of the present invention. Specifically, in FIG. 1, FIG. 5 and FIG. 11 of Japanese Patent Laid-Open No. 2010-63242, the DC module 230 or the electrolytic capacitors C2, C3 are arranged on the left or right relative to the power module 210, in other words, the DC module 230 and the power module 210 are arranged in a planar manner, resulting in a bulge or a size increase of the motor control device 200 or resulting in the generation of a dead space above the semiconductor switching element SSW of the power module 210 (power substrate) in FIG. 7 of Japanese Patent Laid-Open No. 2010-63242. Further, in FIG. 1, FIG. 5 and FIG. 11 of Japanese Patent Laid-Open No. 2010-63242, the DC module 230 (normal filter NF) and the power module 210 are arranged in a planar manner. Furthermore, in FIG. 14 of Japanese Patent Laid-Open No. 2010-63242, the terminal C3NT on the negative side of the electrolytic capacitor C3 is connected with a bus bar 230BNN by welding (Paragraph [0045] of Japanese Patent Laid-Open No. 2010-63242), and in FIG. 4 of Japanese Patent Laid-Open No. 2010-63242, the bus bar 230BNN is connected with the power lead frame 230BN by welding (Paragraph [0028] of Japanese Patent Laid-Open No. 2010-63242). Therefore, the production process of the motor control device 200 (electronic controller) becomes complex or troublesome.

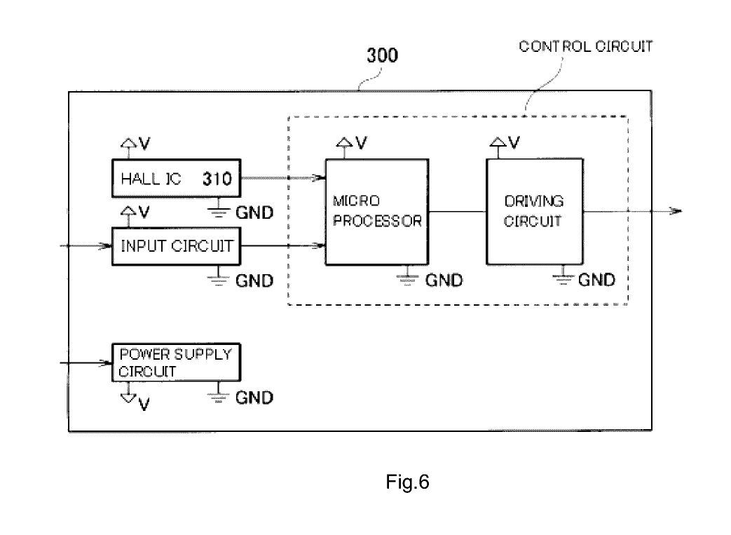

FIG. 6 shows an exemplary functional block diagram of the second substrate 300 in FIG. 3 according to a preferred embodiment of the present invention. In FIG. 3, a control circuit, an input circuit, and the power-supply circuit are not illustrated and are omitted for simplicity's sake, but in the example of FIG. 6, the second substrate 300 can include the control circuit, the input circuit and the power-supply circuit, in addition to the Hall IC 310. Further, in the example of FIG. 6, the control circuit of the second substrate 300 is preferably defined by a microprocessor and a drive circuit, for example.

The control circuit in FIG. 6 controls at least the switching circuit 110 (FET 1 to FET 6) in FIG. 4, and the microprocessor of the control circuit can set the target current. The target current is set depending on the torque signal and the motor current (actual current) taken by the input circuit, the rotation signal taken by the Hall IC 310, and the like. The drive circuit of the control circuit generates six control signals (gate signals) corresponding to the FET 1 to the FET 6, based on the target current. The FET 1 to the FET 6 are turned ON or OFF, by the six control signals (gate signals), and thus, the drive signal (drive current) is supplied to the electric motor 43.

The control circuit can also control the semiconductor relays (FET 7 to FET 11). In this case, the microprocessor of the control circuit determines the ON or OFF of each of the FET 7 to the FET 11, and the drive circuit of the control circuit can generate five control signals (gate signals) corresponding to the FET 7 to the FET 11, based on the determination. The plurality of signal wires 160 on the first substrate 100 in FIG. 3 can transfer not only, for example, the gate signals corresponding to the FET 1 to the FET 11, but also signals having the electric potentials of the shunt resistor R1 to the shunt resistor R3, and can electrically connect the circuit block diagram of FIG. 4 and the functional block diagram of FIG. 6.

FIG. 7A shows an exemplary perspective view of the combinational structure of the first substrate 100 and the relay member 150 in FIG. 3, and FIG. 7B shows an exemplary perspective view of the combinational structure of the first substrate 100, the relay member 150 and the second substrate 300 in FIG. 3. In the example of FIG. 7A, the first substrate 100 includes the connection terminal H1 (first positive terminal), as a node on the line of the electric potential B+ of the positive electrode in FIG. 4, and includes the connection terminal L1 (first negative terminal), as a node on the line of the electric potential B− of the negative electrode in FIG. 4. Here, one end (two protrusion portions) of the connection terminal H1 (first positive terminal) faces one end (two protrusion portions) of the input terminal B+(second positive terminal) of the external connector 440 of the relay member 150, and one end (two protrusion portions) of the connection terminal L1 (first negative terminal) faces one end (two protrusion portions) of the input terminal B− (second negative terminal) of the external connector 440. Here, the other end (one protrusion portion) of the input terminal B+ (second positive terminal) of the external connector 440, for example, is connected with the positive electrode of the battery 61 in FIG. 1, and the other end (one protrusion portion) of the input terminal B− (second negative terminal) of the external connector 440 is connected with the negative electrode of the battery 61.

In the example of FIG. 7B, one end (two protrusion portions) of the connection terminal H1 (first positive electrode terminal) and one end (two protrusion portions) of the input terminal B+ (second positive terminal) of the relay member 150 pierce the second substrate 300, and can also pass through two holes of, for example, six holes at connection regions 106 of the second substrate 300 shown in FIG. 3. Further, in addition to one end (two protrusion portions) of the connection terminal L1 (first negative terminal) and one end (two protrusion portions) of the input terminal B− (second negative terminal) of the relay member 150, the other end (the other protrusion portion) of the connection terminal L1 (first negative terminal) can also pass through three holes of, for example, six holes at the connection regions 106 of the second substrate 300. For example, the connection terminal H1, the input terminal B+, the connection terminal L1 and the input terminal B− that pass through the five holes can be collectively mounted on a surface (front surface) of the second substrate 300, for example, by flow soldering.

Since one end (two protrusion portions) of the connection terminal H1 faces one end (two protrusion portions) of the input terminal B+ of the relay member 150 on the surface (front surface) of the second substrate 300, the input terminal B+ is connected with the connection terminal H1, for example, by flow soldering, and the electric potential B+ of the positive electrode of the battery 61 reaches the connection terminal H1. Similarly, the input terminal B− is connected with the connection terminal L1, and the electric potential B− of the negative electrode of the battery 61 reaches the connection terminal L1. Here, the connection terminal H1 is connected with the connection terminal H2 by the coil 220, one end (one protrusion portion) of the connection terminal H2 can pass through the remaining one hole of, for example, six holes at the connection regions 106 of the second substrate 300, and the electric potential B+ of the positive electrode of the battery 61 reaches the power-supply circuit (see FIG. 6) of the second substrate 300 by the connection terminal H2. Further, the electric potential B− of the negative electrode of the battery 61 reaches the power-supply circuit (see FIG. 6) of the second substrate 300 by the other end (the other protrusion portion) of the connection terminal H1.

In the example of FIG. 6, the power-supply circuit generates the power supply for the Hall IC 310, the input circuit, the microprocessor and the drive circuit. In other words, the power-supply circuit is able to transform the power-supply voltage (the difference between the electric potential B+ of the positive electrode and the electric potential B− of the negative electrode) of the battery 61 into a logical power-supply voltage (the difference between an electric potential V and an electric potential GND).

In the example of FIG. 7A, the relay member 150 includes a plurality of terminals (second input terminals, signal terminals) 460, and in the example of FIG. 7B, the plurality of terminals 460 pass through a plurality of holes at connection regions 461 of the second substrate 300 shown in FIG. 3. At least one terminal 460 of the plurality of terminals 460 inputs the torque signal (external signal), and the torque signal detected by the steering torque sensor 41 reaches the input circuit (see FIG. 6) of the second substrate 300 by the at least one terminal 460. Naturally, the input circuit can input, as external signals, not only the torque signal but also, for example, the vehicle speed signal and the like, by other terminals 460.

In the example of FIG. 7A, the relay member 150 includes the plurality of signal wires 160, and in the example of FIG. 7B, the plurality of signal wires 160 pass through a plurality of holes at a connection region 161 of the second substrate 300 shown in FIG. 3. A portion of the plurality of signal wires 160, for example, transfers the control signals that are sent from the drive circuit of the control circuit in FIG. 6 to the switching circuit 110 (FET 1 to FET 6) in FIG. 4, and the control signals reach the drive circuit of the control circuit in FIG. 6. Further, the remaining portion of the plurality of signal wires 160, for example, transfers the signals (motor currents) having the electric potentials of the shunt resistor R1 to the shunt resistor R3 in FIG. 4, and the signals reach the input circuit in FIG. 6.

In the example of FIG. 7B, the connection terminal H1 (first positive terminal), the input terminal B+ (second positive terminal), the connection terminal L1 (first negative terminal) and the input terminal B− (second positive terminal) are surface-mounted on the surface (front surface) of the second substrate 300, together with the plurality of terminals 460 (second input terminals) and the plurality of signal wires 160, by flow soldering, for example, and therefore, it is possible to simplify the production process of the electronic controller 42. In addition, for example, when at least one terminal 460 (second input terminal) to input the torque signal is mounted on the surface (front surface) of the second substrate 300, it is possible to execute, on the surface (front surface) of the second substrate 300, not only the connection between one end (two protrusion portions) of the connection terminal H1 (first positive electrode terminal) and one end (two protrusion portions) of the input terminal B+ (second positive electrode terminal), but also the connection between one end (two protrusion portions) of the connection terminal L1 (first negative electrode terminal) and one end (two protrusion portions) of the input terminal B− (second negative electrode terminal).

The prior art is unable to produce the benefits of preferred embodiments of the present invention. Specifically, in FIG. 4 and FIG. 5 of Japanese Patent Laid-Open No. 2010-63242, a bus bar 230B having the electric potential of a battery BA is connected with electric components such as the electrolytic capacitors C2, C3 and a relay RY1, by welding (Paragraph [0040] of Japanese Patent Laid-Open No. 2010-63242), and therefore, the production process of the motor control device 200 (electronic controller) becomes complex or troublesome. In addition, in FIG. 4 of Japanese Patent Laid-Open No. 2010-63242, it is necessary to separately execute the connection of a torque sensor TS with a control module 220 and the connection of electric components such as the electrolytic capacitors C2, C3 and the relay RY1 with the bus bar 230B.

In the example preferred embodiment of the present invention shown in FIG. 7A, a hole portion 155 of the relay member 150 shown in FIG. 3 preferably includes a plurality of holes 152, and in the example of FIG. 7B, each of the plurality of signal wires 160 is guided to a plurality of jointing portions (for example, holes or the like) at the connection region 161 of the second substrate 300 shown in FIG. 3, by one corresponding hole 152 of the plurality of holes 152 of the relay member 150.

In the case where the signal wires to transfer the control signals that are sent from the control circuit in FIG. 6 to the switching circuit 110 in FIG. 4 are the plurality of signal wires 160, each of the plurality of signal wires 160 needs to be connected or mounted on the second substrate 300 including the control circuit. On this occasion, since each of the plurality of signal wires 160 is guided to one corresponding jointing portion of the plurality of jointing portions of the second substrate 300, by one corresponding hole 152 of the plurality of holes 152 of the relay member 150, each of the plurality of signal wires 160 is easily connected or mounted on the second substrate 300.

In the example of FIG. 5A, on the bottom surface (first surface) of the frame 103, the connection terminal H3 (third positive electrode terminal) and the connection terminal L1 (first negative terminal) are connected with the positive electrodes (feet) and negative electrodes (feet) of the four electrolytic capacitors 210, respectively. Here, the connection terminal H3 (third positive electrode terminal) is connected with the connection terminal H2 (fourth positive electrode terminal) by the FET 10 and the FET 11 (see FIG. 4), and the electric potential B+ of the positive electrode of the battery 61 reaches the positive electrodes (feet) of the four electrolytic capacitors 210, by the connection terminals H1, H2, H3, the coil 220, the FET 10 and the FET 11. Similarly, the electric potential B− of the negative electrode of the battery 61 reaches the negative electrodes (feet) of the four electrolytic capacitors 210 by the connection terminal L1.

The four electrolytic capacitors 210 are preferably mounted on the connection region 105 (see FIG. 5A) of the surface (front surface) of the first substrate 100, by one end (connection surface) of the connection terminal H3 and the other end (connection surface) of the connection terminal L1, which are shown by a dotted line (105) in FIG. 5B. In this way, the at least one electrolytic capacitor 210 is surface-mounted on the first substrate 100 by the connection surface (105) of the connection terminal H3 and the connection surface (105) of the connection terminal L1, in a state in which the positive electrode and negative electrode of the at least one electrolytic capacitor 210 are connected with the connection terminal H3 (third positive electrode terminal) and the connection terminal L1 (first negative electrode terminal) on the bottom surface (first surface) of the frame 103. Here, the bottom surface (first surface) of the frame 103 is different from the surface (front surface) of the first substrate 100, and therefore, the four electrolytic capacitors 210 are easily mounted on the surface (front surface) of the first substrate 100.

In the example of FIG. 3, the second substrate 300 includes the control circuit (see FIG. 6) that controls the switching circuit 110. The relay member 150 includes the input terminals B+, B− to input the power-supply voltage, and the hole portion 155, and the signal wires 160 to transfer the control signals that are sent from the control circuit to the switching circuit 110, the output terminals U, V, W (motor terminals) to output the drive signal, and the first component 101 (see FIG. 5A) are inserted into the hole portion 155 (151, 152, 153). The cover 420 can store the first substrate 100. An opening portion 425 of the top of the cover 420 is closed by the motor cover 430 (see FIG. 2). Here, a convex portion 423 and the external connector 440 of the relay member 150 can be fitted in concave portions 421, 422 at a lateral portion of the cover 420, respectively, and a plate-shaped cap 428 at a lateral portion of the relay member 150 can close an opening portion 426.

Since the opening portion 425 of the cover 420 is closed by the motor cover 430, the electronic controller 42 does not need to include a cap that is an independent component (for example, the independent metal case 240 in FIG. 1 of Japanese Patent Laid-Open No. 2010-63242). By decreasing the number of the components of the electronic controller 42, it is possible to provide the small-size electronic controller 42 used in electric power steering.

Furthermore, by reference to FIG. 3 showing the electronic controller 42 and FIG. 2 showing the motor cover 430, the first substrate 100, the second substrate 300, the relay member 150 and the motor cover 430 are arranged in the direction (direction DR1) of the motor axis 450 of the electric motor 43, in the order of the second substrate 300, the relay member 150, the first substrate 100 and the motor cover 430. Thus, it is possible to provide the electronic controller 42 integrally with the electric motor 43, on an upper portion or a lower portion of the electric motor 43, in other words, for example, on a back surface of the electric motor 43, and it is possible to inhibit or eliminate a bulge of the electronic controller 42 and to provide the small-size electronic controller 42. Accordingly, the flexibility of the arrangement or design is high, when the electronic controller 42 and the electric motor 43 are incorporated in the electric power steering apparatus 10 or the reduction mechanism 44.

The prior art is unable to provide the benefits of the preferred embodiments of the present invention. Here, in FIG. 2 of Japanese Patent Laid-Open No. 2010-63242, the motor control device 200 (electronic controller) is provided on a lateral portion of the motor 100, integrally with the motor 100, and the motor control device 200 itself forms a bulge as a whole. Accordingly, the flexibility of the arrangement or design is restricted, when the motor control device 200 and the motor 100 are incorporated in the electric power steering apparatus.

In the example of FIG. 3, the first substrate 100 is provided by, for example, a metal substrate, the cover 420 is preferably made of, for example, metal, and a heat conductive member 424 such as grease, for example, is interposed between the first substrate 100 and the cover 420, allowing for the enhancement of the heat radiation of the first substrate 100 (power substrate). Specifically, the heat generated in the switching circuit 110 (FET 1 to FET 6) in FIG. 4 is easily transferred to the first substrate 100 (metal substrate) in FIG. 3, and the heat transferred to the first substrate 100 (metal substrate) is easily transferred to the cover 420 by the heat conductive member 424. On this occasion, the heat transferred to the cover 420 (metal) is easily radiated to the exterior of the cover 420 (metal).

Here, it is only necessary to prepare the cover 420 (metal) that functions as a heat radiator such as a heat radiating plate, for example, and therefore, it is not necessary to prepare both of a cover (that does not function as a heat radiator) and a heat radiator (that does not function as a cover). Further, in the example of FIG. 4, since the first substrate 100 includes the FET 7 to the FET 11 as semiconductor relays, it is possible to decrease the height of the whole of the first substrate 100 (see FIG. 3) and to provide the small-size electronic controller 42.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. An electronic controller for use in electric power steering, the electronic controller being provided integrally with an electric motor, the electronic controller comprising:
a first substrate that includes a switching circuit and at least one electrolytic capacitor, the switching circuit supplying a drive signal to the electric motor, the at least one electrolytic capacitor smoothing a power-supply voltage that is a source of the drive signal;
the at least one electrolytic capacitor being mounted on a first surface;
the switching circuit and the at least one electrolytic capacitor being mounted on a surface of the first substrate, the surface of the first substrate being different from the first surface;
the at least one electrolytic capacitor and the first substrate being arranged above and below the switching circuit, respectively.

2. The electronic controller according to claim 1, wherein
the switching circuit includes a plurality of switching transistors;
the at least one electrolytic capacitor includes a plurality of electrolytic capacitors that are mounted on the first surface; and
at least a portion of the plurality of electrolytic capacitors are arranged above at least a portion of the plurality of switching transistors.

3. The electronic controller according to claim 1, wherein
the first substrate further includes a noise filter that absorbs noise contained in the power-supply voltage;
the noise filter is mounted on the first surface; and
the noise filter is arranged above the switching circuit.

4. The electronic controller according to claim 1, wherein
a positive electrode terminal and a negative electrode terminal are connected with a positive electrode and a negative electrode of the at least one electrolytic capacitor on the first surface, respectively, the positive electrode terminal having an electric potential of a positive electrode of a direct-current power supply, the negative electrode terminal having an electric potential of a negative electrode of the direct-current power supply, the direct-current power supply specifying the power-supply voltage; and
the at least one electrolytic capacitor is mounted on the surface of the first substrate, by a connection surface of the positive electrode terminal and a connection surface of the negative electrode terminal.

5. The electronic controller according to claim 1, wherein the switching circuit and the at least one electrolytic capacitor are collectively mounted on the surface of the first substrate by solder that has been reflowed.
